(19) United States
(12) Patent Application Publication
(10) Pub. No.: US 2006/0019758 A1
(43) Pub. Date: Jan. 26, 2006

(54) Homokinetic joint for a wheel hub

(75) Inventors: Jean-Gerard Loustanau, Fondettes (FR); Domenico Ducci, Marentino (IT); Marcus Caldana, Lidkoping (SE)

Correspondence Address: MERCHANT & GOULD PC, P.O. BOX 2903, MINNEAPOLIS, MN, 55402-0903, US

(73) Assignees: AKTIEBOLAGET SKF, Goteborg (SE); MINGANTI INTERNATIONAL LTD, Dublin 2 (IE)

(21) Appl. No.: 11/126,885

(22) Filed: May 11, 2005

(30) Foreign Application Priority Data
May 14, 2004 (IT) TO2004A000318

(51) Int. Cl. F16C 1/26

(52) U.S. Cl. 464/178

(57) ABSTRACT

Homokinetic joint for a wheel hub, the homokinetic joint being able to be coupled in rotation to a spindle of the relative wheel hub in order to rotate around a rotation axis (A), and being provided with a coupling end which is inserted inside an axial passing housing of the spindle, and with a coupling device, which is suitable for transmitting a torque moment between the homokinetic joint and the wheel hub, and which presents two connecting outlines, which are obtained around the coupling end and, respectively, inside the axial housing; and presenting a shape which is complementary in relation to each other, and a radius (R) of angularly variable dimensions with continuity on a plane which is transverse to the rotation axis (A); the two connecting outlines being both provided, in relation to the rotation axis (A), with at least one convex portion.

The present invention relates to a homokinetic joint for a wheel hub.

In general, well-known kinds of homokinetic joints for wheel hubs are coupled in such a way as to be able to rotate around a spindle of the relative wheel hub, and comprise a cylindrical coupling end which is inserted inside an axial passing housing of the spindle, and a coupling device, which is shared between the cylindrical end and the axial housing, and which usually comprises a grooved outline which is suitable for transmitting a torque moment between the homokinetic joint and the wheel hub.

Homokinetic joints of the kind which have just been described, while having been shown to be reliable and resistant, have however demonstrated some disadvantages which are essentially due to the complexity, mainly geometrical but also in terms of production, of the above-mentioned grooved outline also in consideration of the relatively difficult level of manipulation of the relative coupling end.

The aim of the present invention is to produce a homokinetic joint for a wheel hub, which will permit the resolution of the above-described disadvantages in a simple and cost-effective manner.

According to the present invention a homokinetic joint for a wheel hub will be produced, the homokinetic joint being able to be coupled in such a way as to rotate around a spindle of the relative wheel hub in order to rotate around a rotation axis, and comprising:
a coupling end which is inserted inside a passing axial housing of the spindle; and
   a coupling device, which is suitable for transmitting a torque moment between the homokinetic joint and the wheel hub, and which comprises, in its turn, a first connecting outline which is obtained around the coupling end, and a second connecting outline which is obtained inside the axial housing; the homokinetic joint being characterised by the fact that the said first and second connecting outlines present a shape which is complementary to each other, and a radius of angularly variable dimensions with continuity on a plane which is transverse to the rotation axis; the first and second connecting outlines both comprising, in relation to the rotation axis, at least one respective convex portion.

The present invention will now be described with reference to the attached drawings, which illustrate a non-limiting of embodiment of the present invention, in which:

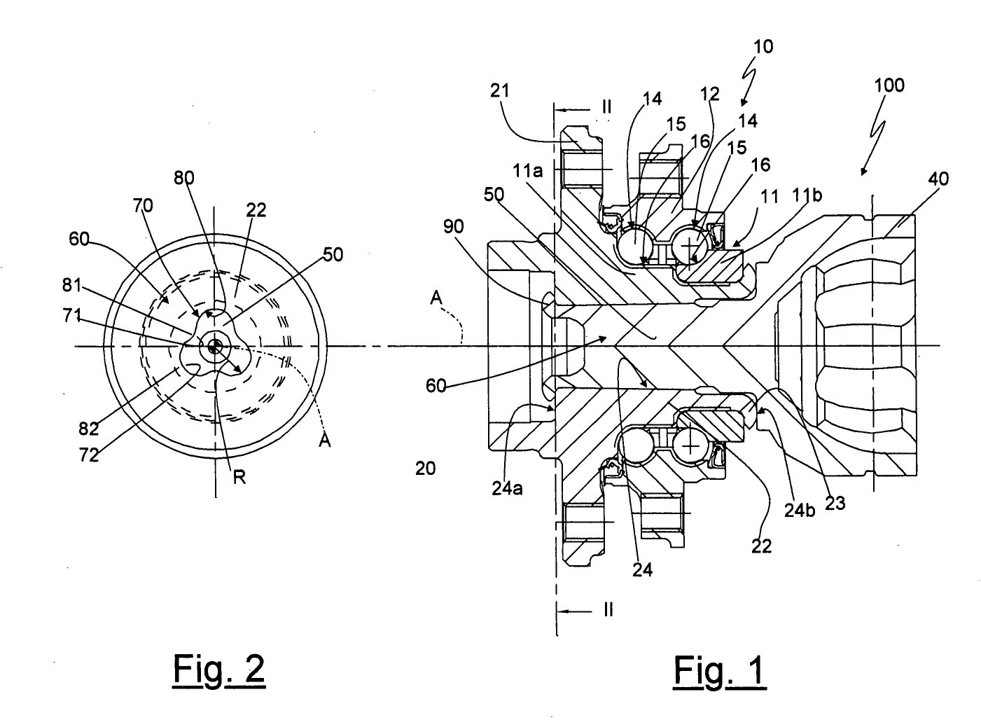

FIG. 1 is a section view of a preferred form of embodiment of a homokinetic joint for a wheel hub produced according to the present invention; and

FIG. 2 shows a section along the line II-II which is shown in FIG. 1.

With reference to FIG. 1, the number 100 indicates in its entirety a homokinetic joint, which is coupled to a bearing wheel hub unit, indicated with the numbers 10 and 20 respectively, in such a way as to be able to rotate around a rotation axis A.

The bearing 10 comprises an inner race 11 which is co-axial to the axis A, an outer race 12 which is co-axial to the inner race 11, and two crowns 14 of rolling bodies 15, which are interposed between the two races 11 and 12, and which are both mounted inside a respective rolling track 16.

In the form of embodiment which is shown in FIG. 1, the rolling bodies 15 are defined by spheres, and the inner race 11 comprises a portion 11a which is integrated with the wheel hub 20 and is provided with a relative track 16a, and a portion 11b which is mounted on the wheel hub 20 itself and is provided with a relative track 16b.

The wheel hub 20 comprises a flange 21 which is transverse to the axis A, and a spindle 22, which is integral with the flange 21 itself, and which extends along the axis A inside the inner race 11 ending in a small rolled border 23 which abuts the portion 11b itself in order to axially block the portion 11b against the portion 11a.

The spindle 22 presents an axial passing housing 24, which extends for the whole of the length of the spindle 22 itself along the axis A, and is axially delimited by an outlet surface 24a and an entry surface 24b. In particular, the surfaces 24a and 24b are both transverse to the axis A and external to the housing 24, and, in addition, the surface 24b is substantially defined by the small border 23.

The homokinetic joint 100 comprises a dome 40 which is arranged in such a way as to abut the small border 23, and an end body 50, which is integral with the dome 40, and which is inserted inside the housing 24 in order to couple the homokinetic joint 100 to the wheel hub 20 in such a way that it can rotate.

In addition, the homokinetic joint 100 comprises a coupling device 60, which is suitable for transmitting a torque moment between the body 50 and the wheel hub 20, and which comprises, in its turn, a peripheral connecting outline 70 which is obtained around the body 50, and a complementary connecting outline 80 which is obtained inside the axial housing 24, and which presents a shape which is complementary to a shape of the peripheral outline 70.

In particular, as is better illustrated in FIG. 2, the outlines 70 and 80 present a radius R of angularly variable dimensions with continuity on a plane which is transverse to the axis A, and both comprise a number N1 of convex portions 71 and 81 in relation to the axis A itself, and a number N2 of concave portions 72 and 82 also in relation to the axis A. The values of the numbers N1 and N2 depend on the necessary construction and planning characteristics, and may be equal to each other as in cases of this kind, or may be different from each other.

FIG. 2 illustrates a case in which both the number N1 and the number N2 have a value which is equal to three and the portions 71, 81 and 72, 82 are alternated in relation to each other around the axis A. Alternatively, and in a way which is easily understandable from the foregoing description, the outlines 70 and 80 may each be provided with only one relative convex portion 71, 81 arranged between two relative concave portions 72, 82 contiguous in relation to each other.

In addition, the outlines 70 and 80 present a tapering shape which decreases towards the surface 24a, or rather decreases in the direction of the introduction of the body 50 inside the axial housing 24, in order to permit the axial blocking of the body 50 inside the spindle 22.

Finally, the homokinetic joint 100 comprises a small border 90, which defines a free end portion of the body 50, and is turned up and rolled in such a way as to abut the outlet surface 24a of the axial housing 24 in order to axially block in definitive fashion the body 50 itself inside the axial housing 24, and to render the dome 40 in contact with the entry surface 24b, or rather against the small border 23.

It is intended that the present invention should not be limited to the form of embodiment which is herein described and illustrated, which is to be considered as an example of a form of embodiment of the homokinetic joint for a wheel hub, and which might instead by subject to further modifications relating to the shape and disposition of its parts, as well as to details pertaining to construction and assembly.

1. Homokinetic joint (100) for a wheel hub (20), the homokinetic joint (100) being able to be coupled in such a way as to rotate around a spindle (22) of the relative wheel hub (20) in order to rotate around a rotation axis (A), and comprising:
a coupling end (50) which is inserted inside a passing axial housing (24) of the spindle (22); and
a coupling device (60), which is suitable for transmitting a torque moment between the homokinetic joint (100) and the wheel hub (20), and which comprises, in its turn, a first connecting outline (70) which is obtained around the coupling end (50), and a second connecting outline (80) which is obtained inside the axial housing (24);
the homokinetic joint (100) being characterised by the fact that the said first and second connecting outlines (70, 80) present a shape which is complementary to each other, and a radius (R) of angularly variable dimensions with continuity on a plane which is transverse to the rotation axis (A); the first and second connecting outlines (70, 80) both comprising, in relation to the rotation axis (A), at least one respective convex portion (71, 81).

2. Homokinetic joint according to claim 1, characterised by the fact that the first and second connecting outlines (80) both comprise, in relation to the rotation axis (A), a first determined number (N1) of convex portions (71, 81), and a second determined number (N2) of concave portions (72, 82).

3. Homokinetic joint according to claim 2, characterised by the fact that the first determined number (N1) of convex portions (71, 81) and the second determined number (N2) of concave portions (72, 82) coincide with each other; the convex portions (71, 81) alternating around the rotation axis (A) in relation to the concave portions (72, 82).

4. Homokinetic joint according to claims 2 or 3, characterised by the fact that the first and second connecting outlines (70, 80) are conformed in a tapering shape in relation to the rotation axis (A).

5. Homokinetic joint according to claims 2, 3 or 4, characterised by the fact that the said coupling end (50) comprises a small border which is turned up and rolled in such a way as to abut an outlet surface (24a) of the said axial housing (24).
